(19) United States
(12) Patent Application Publication
(10) Pub. No.: US 2024/0201972 A1
(43) Pub. Date: Jun. 20, 2024

(54) SCHEDULING A SOFTWARE UPDATE ON AN INDUSTRIAL MACHINE

(71) Applicant: International Business Machines Corporation, Armonk, NY (US)

(72) Inventors: Sarbajit K. Rakshit, Kolkata (IN); Raghuveer Prasad Nagar, Kota (IN); Jagadesh Ramaswamy Hulugundi, Bangalore (IN); Dinesh Kumar Bhudavaram, Bangalore (IN)

(21) Appl. No.: 18/065,649

(22) Filed: Dec. 14, 2022

(51) Int. Cl. G06F 8/65

(52) U.S. Cl. CPC G06F 8/65

(57) ABSTRACT

Embodiments of the present invention provide an approach for scheduling a software update on an industrial machine based on a specification, predicted usage and role of the machine. Specially, based on a historical learning, the system and method provide for analyzing an activity workflow sequence of a workflow execution in an industrial floor. The analysis includes examining how the industrial machines are collaborating with each other, whether the activities are performed in parallel or in sequence, a time duration involvement of the machines while performing the activities, a time required an installation of the software update, and any scheduled industrial machine maintenance. Based on the analysis, an appropriate time and sequence when for software update installation can be performed is identified so that there is little or no negative impact during workflow execution.

### TECHNICAL FIELD

The present invention relates to managing software updates, and more specifically to embodiments for scheduling a software update on an industrial machine based on a specification, predicted usage and role of the industrial machine.

### BACKGROUND

Over-the-air programming (OTA) refers to various methods of distributing new software, configuration settings, and even updating encryption keys to devices like mobile phones, set-top boxes, electric cars or secure voice communication equipment. Updating software and firmware using OTA has increased in the handheld devices, industrial, and automotive sectors for the embedded platform with time. Once a product is in the real world, a firmware or software update related to a bug fix, security fix, or a feature update can be required for the betterment of the device and seamlessly delivered via OTA.

### SUMMARY

Embodiments of the present invention provide an approach for scheduling a software update on an industrial machine based on a specification, predicted usage and role of the machine. Specially, based on a historical learning, the system and method provide for analyzing an activity workflow sequence of a workflow execution in an industrial floor. The analysis includes examining how the industrial machines are collaborating with each other, whether the activities are performed in parallel or in sequence, a time duration involvement of the machines while performing the activities, a time required for an installation of the software update, and any scheduled industrial machine maintenance. Based on the analysis, an appropriate time and sequence when a software update installation can be performed is identified so that there is little or no negative impact during workflow execution.

A first aspect of the present invention provides a method for scheduling a software update installation on industrial machines in an Internet of Things (IoT) environment, comprising: receiving, by a processor, a plurality of log files and IoT data feeds related to a set of industrial machines; calculating, by the processor, using the plurality of log files, an installation time estimate to perform the software installation; analyzing, by the processor, using the plurality of log files and IoT data feeds, a set of activities and an activity sequence related to a workflow execution using a machine learning technique to identify a planned time and sequence of a software update installation on an industrial machine among the set of industrial machines based on the installation time estimate, wherein the set of industrial machines are part of an integrated workflow system; performing, by the processor, a digital twin simulation to identify a potential negative impact in the workflow execution based on a downtime of the industrial machine during the planned time of the software update installation; and proactively reconfiguring, by the processor, a resource allocation to minimize the potential negative impact.

A second aspect of the present invention provides a computing system for scheduling a software update installation on industrial machines in an Internet of Things (IoT) environment, comprising: a processor; a memory device coupled to the processor; and a computer readable storage device coupled to the processor, wherein the storage device contains program code executable by the processor via the memory device to implement a method, the method comprising: receiving, by a processor, a plurality of log files and IoT data feeds related to a set of industrial machines; calculating, by the processor, using the plurality of log files, an installation time estimate to perform the software installation; analyzing, by the processor, using the plurality of log files and IoT data feeds, a set of activities and an activity sequence related to a workflow execution using a machine learning technique to identify a planned time and sequence of a software update installation on an industrial machine among the set of industrial machines based on the installation time estimate, wherein the set of industrial machines are part of an integrated workflow system; performing, by the processor, a digital twin simulation to identify a potential negative impact in the workflow execution based on a downtime of the industrial machine during the planned time of the software update installation; and proactively reconfiguring, by the processor, a resource allocation to minimize the potential negative impact.

A third aspect of the present invention provides a computer program product for scheduling a software update installation on industrial machines in an Internet of Things (IoT) environment, the computer program product comprising a computer readable storage device, and program instructions stored on the computer readable storage device, to: receive, by a processor, a plurality of log files and IoT data feeds related to a set of industrial machines; calculate, by the processor, using the plurality of log files, an installation time estimate to perform the software installation; analyze, by the processor, using the plurality of log files and IoT data feeds, a set of activities and an activity sequence related to a workflow execution using a machine learning technique to identify a planned time and sequence of a software update installation on an industrial machine among the set of industrial machines based on the installation time estimate, wherein the set of industrial machines are part of an integrated workflow system; perform, by the processor, a digital twin simulation to identify a potential negative impact in the workflow execution based on a downtime of the industrial machine during the planned time of the software update installation; and proactively reconfigure, by the processor, a resource allocation to minimize the potential negative impact.

### BRIEF DESCRIPTION OF THE DRAWINGS

FIG. 1 depicts a block diagram illustrating an example of an environment for the execution of at least some of the computer code involved in performing the inventive methods, in accordance with embodiments of the present invention.

FIG. 2 depicts a block diagram of a distributed system involved in performing the inventive methods, in accordance with embodiments of the present invention.

FIG. 3 depicts a block diagram of one or more components of a system environment by which services provided by one or more components of an embodiment system may be offered as cloud services, in accordance with an embodiment of the present invention.

FIG. 4 depicts a flow chart of a method for scheduling a software update on an industrial machine based on a specification, predicted usage and role of the machine, in accordance with embodiments of the present invention.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

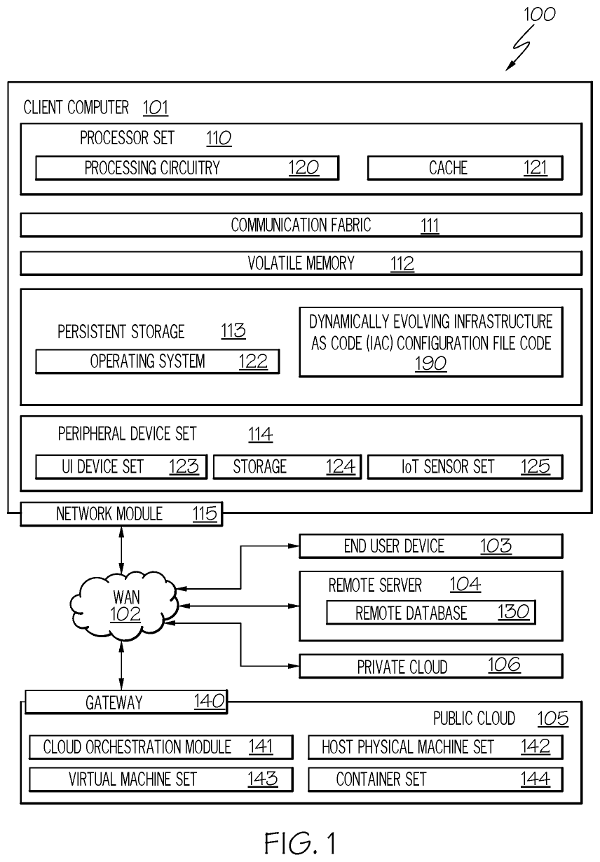

Computing environment 100 of FIG. 1 contains an example of an environment for the execution of at least some of the computer code involved in performing the inventive methods, such as scheduling a software update on an industrial machine based on a specification, predicted usage and role of the industrial machine. In addition to block 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 190, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 190 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Industrial environments, such as environments for large scale manufacturing, energy production environments, energy extraction environments, and others, involve highly complex industrial machines, devices and systems and highly complex workflows, in which operators must account for a host of parameters, metrics, and the like in order to optimize design, development, deployment, and operation of different technologies in order to improve overall results. The rise of computer technology, cloud computing, big data, and the like can enable further automation and even provide intellectualization of production. In order to improve business competitiveness, control costs and guarantee quality, a long-term pursuit of industrial environments might be to continually improve the workings of their industrial machines via software updates which can include one or more updates to provide any number of new or enhanced features, enhance speed, address any security vulnerabilities, and/or the like.

Today, industrial machines, robots, material movement vehicles, etc. can be configured to have software updates applied using over-the-air (OTA). The installation of a software update on an industrial machine can typically take up to 90 minutes. During this time, the industrial machine is locked, and its functions are not available. A typical industrial machine performs as per a workflow. A workflow is a series of event-triggered tasks or actions within an organization to produce a final outcome. The actions may be performed by people, systems, or machines. Workflow is a way of describing the order of execution and the dependent relationships between both long running and short processes without the need to dictate coding details. These concepts are now available in the manufacturing space with purpose-designed workflow engines that have the added consideration of robustness, speed, and quick deployment that manufacturers need.

Industrial environments are widely populated with large, complex, heavy machines that are designed to have very long working lifetimes and have ongoing service requirements, including requirements for scheduled maintenance and for often unanticipated repairs. Many of the large industrial machines that require ongoing maintenance, service and repairs are involved in high stakes production processes and other processes, such as energy production, manufacturing, mining, drilling, and transportation, that preferably involve minimal or no interruption. If an OTA software update does not happen in a planned manner, then there can be a problem with executing the workflow. An extended delay in an OTA operation that requires a shutdown of a machine that is critical to such a process can cost thousands, or even millions of dollars per day. What is needed is a way by which such installation of software can be planned on industrial machines in a productive way.

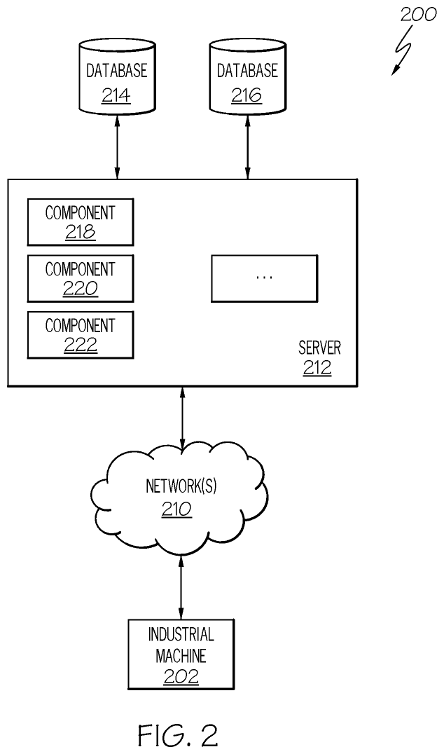

FIG. 2 depicts a block diagram of a distributed system 200 for implementing one or more of the embodiments. In the illustrated embodiment, distributed system 200 includes one or more industrial machines 202, which are configured to execute and operate a client application such as a web browser, proprietary client, or the like over one or more network(s) 210. Server 212 may be communicatively coupled with remote industrial machine 202.

In various embodiments, server 212 may be adapted to run one or more services or software applications provided by one or more of the components 218, 220, 222 of the system. In some embodiments, these services may be offered as web-based or cloud services or under a Software as a Service (Saas) model to one or more industrial machines 202.

In the configuration depicted in FIG. 2, the software components 218, 220, and 222 of system 200 are shown as being implemented on server 212. Industrial machine 202 may utilize one or more client applications to use the services provided by these components 218, 220, and 222. These components 218, 220, and 222 may be implemented in hardware, firmware, software, or combinations thereof. It should be appreciated that various different system configurations are possible, which may be different from distributed system 200. The embodiment shown in the figure is thus one example of a distributed system for implementing an embodiment system and is not intended to be limiting. Although exemplary distributed system 200 is shown with one industrial machine 202, any number of industrial machines may be supported.

Network(s) 210 in distributed system 200 may be any type of network familiar to those skilled in the art that can support data communications using any of a variety of commercially available protocols, including without limitation TCP/IP (transmission control protocol/Internet protocol), SNA (systems network architecture), IPX (Internet packet exchange), AppleTalk, and the like. For example, network(s) 210 can be a local area network (LAN), such as one based on Ethernet, Token-Ring and/or the like. Network(s) 210 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 212 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 212 may be adapted to run one or more services or software applications described in the foregoing disclosure. For example, server 212 may correspond to a server for performing processing described above according to an embodiment of the present disclosure.

In some implementations, server 212 may include one or more applications to analyze and consolidate data feeds and/or event updates received from industrial machine 202. As an example, data feeds and/or event updates may include, but are not limited to, real-time updates received from one or more third party information sources and continuous data streams, which may include real-time events related to sensor data applications, network performance measuring tools (e.g., network monitoring and traffic management applications), clickstream analysis tools, automobile traffic monitoring, and/or the like. Server 212 may also include one or more applications to display the data feeds and/or real-time events via one or more display devices of industrial machine 202.

Distributed system 200 may also include one or more databases 214 and 216. Databases 214 and 216 may reside in a variety of locations. In an example, one or more of databases 214 and 216 may reside on a non-transitory storage medium local to (and/or resident in) server 212. Alternatively, databases 214 and 216 may be remote from server 212 and in communication with server 212 via a network-based or dedicated connection. In one set of embodiments, databases 214 and 216 may reside in a storage-area network (SAN). Similarly, any necessary files for performing the functions attributed to server 212 may be stored locally on server 212 and/or remotely, as appropriate. In one set of embodiments, databases 214 and 216 may include relational databases that are adapted to store, update, and retrieve data in response to computing language commands.

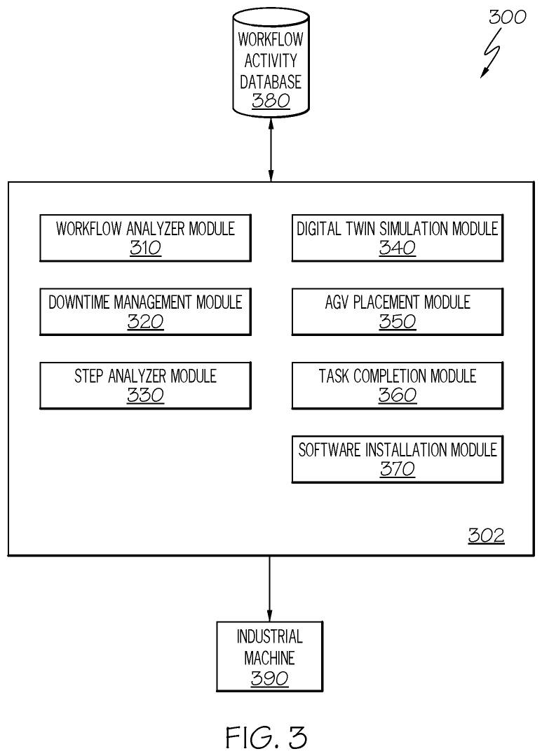

FIG. 3 depicts a block diagram of one or more components of a system environment 300 by which services provided by one or more components of an embodiment system may be offered as cloud services, in accordance with an embodiment of the present invention. In the illustrated embodiment, system environment 300 includes one or more industrial machines 390 to interact with management system 302 that provides software management services. It should be appreciated that management system 302 depicted in FIG. 3 may have other components than those depicted. Further, the embodiment shown in the figure is only one example of a cloud infrastructure system that may incorporate an embodiment of the invention. In some other embodiments, management system 302 may have more or fewer components than shown in FIG. 3, may combine two or more components, or may have a different configuration or arrangement of components. Management system 302 may comprise one or more computers and/or servers that may include those described above for server 212 of FIG. 2. Similarly, the system may comprise one or more databases (e.g., workflow activity database 380) that may include those described above (i.e., database 214 and 216) in FIG. 2.

Today, Internet of Things (IOT) in manufacturing can lower maintenance costs and improve overall productivity. Over-the-air (OTA) software updates provide a way of efficiency to enable the transition of legacy manufacturing to the era of smart manufacturing. In an embodiment, planned software update management functionality may include capabilities for providing an OTA solution which can provide a planned secure, robust and scalable delivery mechanism to the building blocks of the smart factory, delivering the latest software and firmware updates to a company's operating assets (e.g., industrial machines).

The proposed delivery mechanism is an artificial intelligence (AI) enabled system that identifies appropriate timing and sequence when a new version of software or software update can be installed in various machines so that any impact or potential disruption can be minimized during workflow execution. Machine learning is seen as a part of artificial intelligence. Machine learning is a field of inquiry devoted to understanding and building methods that ‘learn’, that is, methods that leverage data to improve performance on some set of tasks. Machine learning involves a training step. Training is the most important step in machine learning. In training, prepared data is passed to the machine learning algorithm (or model) to find patterns and make predictions. It results in the model learning from the data so that it can accomplish the task set. Over time, with training, the algorithm gets better at predicting as it receives additional data in the future.

As shown in FIG. 3, cloud management functionality may be provided by one or more modules, such as workflow analyzer module 310, downtime management module 320, step analyzer module 330, digital twin simulation module 340, AGV placement module 350, task completion module 360 and software installation module 370.

Workflow analyzer module 310 is configured to analyze an activity workflow sequence in an industrial floor containing any number of industrial machines 390. The progress of every workflow execution of industrial machine 390 can be recorded in a log file which can be received by workflow analyzer module 310. In an embodiment, log files can be stored in workflow activity database 380. The log file can include, but is not limited to, a detailed, complete, and consistent record of every event that occurred during each workflow execution. An event represents a discrete change in a workflow execution's state, such as a new activity being scheduled, or a running activity being completed. The log file can contain every event that causes the execution state of the workflow execution to change, such as scheduled and completed activities, task timeouts, and signals.

In addition, IoT feeds can be received by workflow analyzer module 310. IoT feeds can identify how the industrial machines 390 are collaborating with each other within an industrial IoT environment. The environment can comprise networked smart industrial machines 390 which enable real-time, intelligent, and autonomous access, collection, analysis, communications, and exchange of process, product and/or service information, within the industrial environment, so as to optimize overall production value. The IoT feeds can show which industrial machines 390 are involved in different workflow activities. The log files and IoT feeds can further show a sequence of the different industrial machines 390 when performing the workflow activities. For example, a first industrial machine might need to complete its task before a second industrial machine performs its task as part of a particular workflow execution. In an embodiment, the IoT feeds can be stored in workflow activity database 380.

Workflow analyzer module 310, using tools like Watson®, can learn (using a machine learning model) to identify an appropriate timing and sequence when a software update can be installed in various industrial machines through analysis of historical data (i.e., log files and IoT feeds) which can be stored in workflow activity database 380. (Watson is a trademark of International Business Machines in the U.S. and/or other countries). The timing and sequence of any software installation is critical to manufacturers as they seek to mitigate any negative impact to productivity.

Based on historical learning, the workflow activity module 310 can identify an appropriate timing and sequence when a software update can be installed in various industrial machines so that there is little or no negative impact or problem during workflow execution. To accomplish this, using historical data, workflow activity module 310 analyzes how the industrial machines 390 are collaborating with each other, whether activities are performed in parallel or in sequence, time duration involvements of the industrial machines 390 while performing their respective activities, an estimated time required for installation of the new version of a software, and any predicted or scheduled preventive maintenance of any industrial machine 390. Since the industrial machines 390 add significant value, manufacturers strive for high machine up-time. However, some downtime is inevitable. At a minimum, there is likely planned downtime for machine maintenance. Despite best efforts, occasionally machines do also breakdown. Based on historical data, workflow analyzer module 310 attempts to identify this downtime, both as part of the regular scheduling process and through what-if analysis to plan around the unexpected.

Downtime management module 320 is configured to, based on a predicted downtime duration in various machines, proactively arrange appropriate backup or alternative industrial machines (including manufacturing machines, robots, automated guided vehicles or “AGVs”, and/or the like) to support during the installation period, so that an activity workflow is continued and there is no reduction in throughput. Machine downtime is time accumulated when a manufacturing process is stopped for any planned or unplanned event (e.g., a motor failure). For example, downtime can be triggered by material issues, a shortage of operators, or scheduled/unscheduled maintenance. For many manufacturers, downtime is the single largest source of lost production time.

An alternative or backup industrial machine can be arranged to quickly replace an industrial machine experiencing downtime. For example, during times of scheduled maintenance of industrial machine 390, downtime management module 320 can proactively switch over to the alternative industrial machine so that it can act on behalf of the normal machine to ensure that the activity workflow doesn't bottleneck during the downtime period.

Step analyzer module 330 is configured to analyze any activities of industrial machine 390 to identify a step of an activity workflow that does not require any computing capability, and if the time required to complete the step of the activity is sufficient to install a software update. If sufficient time exists for installation, step analyzer module 330 can schedule a software installation for the industrial machine 390. For example, a step of an activity workflow can involve an AGV being loaded with material for a movement. During this step, the AGV will not be using any of its computing capability. Assume that this loading step takes 5 minutes and an estimated time for performing the software installation takes only 2 minutes. In this case, the software installation can be performed during the loading step without any negative impact to the workflow activity since the AGV is not using any computing capability during that time.

Digital twin simulation module 340 is configured to perform a digital twin simulation on industrial machines 390 to identify any negative impact in a different part of a workflow execution because of a software installation downtime. If a negative impact is identified, digital twin simulation module 340 is configured to perform steps to mitigate the negative impact. A digital twin is a virtual representation—a true-to-reality simulation of physics and materials—of a real-world physical asset or system, which is continuously updated.

Internet of Things (IOT) helps enable connected machines and devices to share data with their digital twins and vice versa. That's because digital twins are always on and up-to-date computer-simulated versions of real-world IoT-connected physical things or processes they represent. Digital twins are virtual representations that can capture the physics of structures and changing conditions internally and externally, as measured by a myriad connected sensors. They can also run simulations within the virtualizations to test for problems. One of the biggest benefits of using a simulation model that is purely based on digital twin technology is for its potential to accurately determine the implications and effects of how the duplicated object will perform in the future based on the changes that were made related to the software installation downtime. Any negative effects that are discovered can be communicated to a manufacturer. Alternatively or in addition, digital twin simulation module 340 can mitigate the negative effects by cancelling or rescheduling the software installation for a time when the simulation estimates no negative implications or effects are expected.

AGV placement module 350 is configured to identify an appropriate place on an industrial floor and duration of availability of that place where any AGVs can be moved for a software update installation. The purpose of locating this place is so that during the software update installation on the AGVs that they are not blocking the mobility path of other AGVs. Sometimes called self-guided vehicles or autonomous guided vehicles, automated guided vehicles (AGVs) are material handling systems or load carriers that travel autonomously throughout a warehouse, distribution center, or manufacturing facility, without an onboard operator or driver. Based on historical data stored in workflow activity database 380, AGV placement module 350 can determine the mobility paths of the AGVs during a workflow activity to be performed during a scheduled software installation. An AGV can follow along marked long lines or wires on the floor, or uses radio waves, vision cameras, magnets, or lasers for navigation. So that the workflow activity is not disrupted, these mobility paths must be kept clear for other AGVs to be able to perform their tasks.

Based on the identified duration of downtime in an industrial machine while a software update is installed, task completion module 360 is configured to proactively engage the industrial machine to complete its designated task in a workflow activity in advance of the downtime so that the effect of the downtime due to software update installation can be minimized. Software installation module 370 is configured to perform an OTA software update on an industrial machine 390 during its identified downtime. An OTA update is the wireless delivery of the software update to the industrial machine 390. In some instances, OTA updates may provide additional functionality to the industrial machine 390.

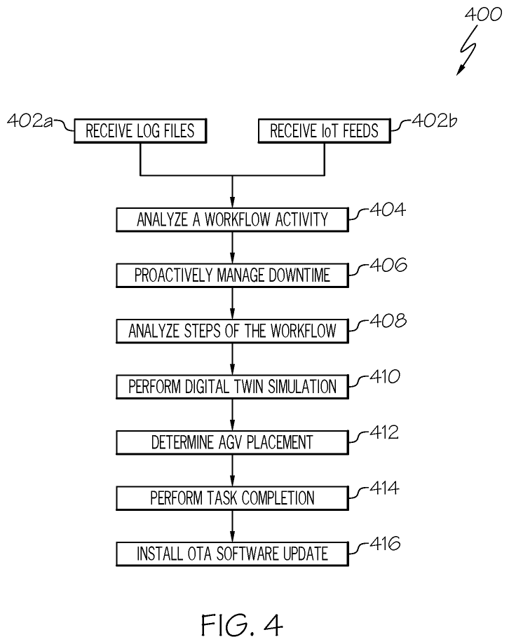

FIG. 4 depicts a flow chart of a method 400 for scheduling a software update on an industrial machine based on a specification, predicted usage and role of the industrial machine. Embodiments of the method 400 for scheduling a software update on an industrial machine based on a specification, predicted usage and role of the industrial machine, in accordance with embodiments of the present invention, may begin at steps 402a, 402b wherein workflow analyzer module 310 receives log files and IoT feeds for each industrial machine 390 to analyze an activity workflow sequence in an industrial floor. Machine log data can include machine generated data showing the tasks performed by an industrial machine 390, the length of each task, success or failure of each task, etc. IoT devices typically include sensors, software, or electronics actuators that are connected to allow for exchange of data gathered. These data feeds can allow for the monitoring of interaction between the industrial machines 390 as they perform the activities necessary for the workflow. The data received (log files, IoT feeds, etc.) can be stored in workflow activity database 380.

At step 404, workflow analyzer module 310 analyzes, based on historical data received (e.g., log files and IoT feeds), an appropriate timing and sequence when a software update can be installed in various industrial machines so that there is little or no negative impact or problem during workflow execution. To accomplish this, using historical data, workflow analyzer module 310 analyzes how the industrial machines 390 are collaborating with each other, whether activities are performed in parallel or in sequence, a time duration involvement of each industrial machine 390 while performing its activities, an estimated time required for installation of a software update, and any predicted or scheduled preventive maintenance of any of the industrial machines 390.

At step 406, if a potential software update installation is determined for any industrial machine 390 (e.g., manufacturing machine, robot, AGV, etc.), then based on a predicted downtime duration in the various industrial machines, downtime management module 320 proactively arranges appropriate backup industrial machines to support a workflow activity during the installation period, so that activity workflow is continued and there is no reduction in throughput. At step 408, step analyzer module 330 analyzes any activities of industrial machine 390 to identify a step of an activity workflow that does not require any computing capability, and whether the time required to complete the step of the activity is sufficient to install a software update. If so, the potential software update installation is scheduled.

Digital twin simulation module 340, at step 410, performs a digital twin simulation to identify any negative impact in a different part of a workflow execution because of a software installation downtime. If a negative impact is identified, digital twin simulation module 340 is configured to perform steps to mitigate the negative impact. For example, AGV placement module 350, at step 412, identifies an appropriate place on the industrial floor and duration of availability at that place where any AGVs can be moved for software update installation, so that during the installation the AGVs are not blocking the mobility path of other AGVs. In a second example, at step 414, task completion module 360 proactively engages an industrial machine 390 to complete its designated task in a workflow activity in advance of its downtime so that the effect of the downtime due to software update installation can be minimized. Software installation module 370, at step 416, performs an OTA software update on an industrial machine 390 during its identified downtime. An OTA update is the wireless delivery of the software update to the industrial machine 390.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for scheduling a software update installation on industrial machines in an Internet of Things (IOT) environment, comprising:
receiving, by a processor, a plurality of log files and IoT data feeds related to a set of industrial machines;
calculating, by the processor, using the plurality of log files, an installation time estimate to perform the software installation;
analyzing, by the processor, using the plurality of log files and IoT data feeds, a set of activities and an activity sequence related to a workflow execution using a machine learning technique to identify a planned time and sequence of a software update installation on an industrial machine among the set of industrial machines based on the installation time estimate, wherein the set of industrial machines are part of an integrated workflow system;
performing, by the processor, a digital twin simulation to identify a potential negative impact in the workflow execution based on a downtime of the industrial machine during the planned time of the software update installation; and
proactively reconfiguring, by the processor, a resource allocation to minimize the potential negative impact.

2. The method of claim 1, further comprising performing, by the processor, the software installation on the industrial machine based on the planned time and sequence.

3. The method of claim 1, wherein the step of analyzing the set of activities and the activity sequence related to a workflow execution includes identifying how the industrial machine collaborates with the remaining industrial machines in the set of industrial machines.

4. The method of claim 1, wherein the step of analyzing the set of activities and the activity sequence related to a workflow execution includes identifying which activities among the set of activities is performed in parallel and which activities among the set of activities are performed in sequence and an estimated time duration to perform each activity among the set of activities.

5. The method of claim 1, wherein the step of analyzing the set of activities and the activity sequence related to a workflow execution further comprises:
identifying a step of an activity related to the industrial machine that does not require computing capability; and
calculating whether a time required to complete the step is sufficient to perform the software update installation based on the installation time estimate.

6. The method of claim 1, further comprising identifying, by the processor, a location on an industrial floor to move the industrial machine to perform the software update installation.

7. The method of claim 1, further comprising proactively engaging, by the processor, the industrial machine to complete a predefined task in advance of the planned time of the software update installation.

8. A computing system for scheduling a software update installation on industrial machines in an Internet of Things (IOT) environment, comprising:
a processor;
a memory device coupled to the processor; and
a computer readable storage device coupled to the processor, wherein the storage device contains program code executable by the processor via the memory device to implement a method, the method comprising:
receiving, by a processor, a plurality of log files and IoT data feeds related to a set of industrial machines;
calculating, by the processor, using the plurality of log files, an installation time estimate to perform the software installation;
analyzing, by the processor, using the plurality of log files and IoT data feeds, a set of activities and an activity sequence related to a workflow execution using a machine learning technique to identify a planned time and sequence of a software update installation on an industrial machine among the set of industrial machines based on the installation time estimate, wherein the set of industrial machines are part of an integrated workflow system;
performing, by the processor, a digital twin simulation to identify a potential negative impact in the workflow execution based on a downtime of the industrial machine during the planned time of the software update installation; and
proactively reconfiguring, by the processor, a resource allocation to minimize the potential negative impact.

9. The computing system of claim 8, further comprising performing, by the processor, the industrial machine based on the planned time and sequence.

10. The computing system of claim 8, wherein the step of analyzing the set of activities and the activity sequence related to a workflow execution includes identifying how the industrial machine collaborates with the remaining industrial machines in the set of industrial machines.

11. The computing system of claim 8, wherein the step of analyzing the set of activities and the activity sequence related to a workflow execution includes identifying which activities among the set of activities is performed in parallel and which activities among the set of activities are performed in sequence and an estimated time duration to perform each activity among the set of activities.

12. The computing system of claim 8, wherein the step of analyzing the set of activities and the activity sequence related to a workflow execution further comprises:
identifying a step of an activity related to the industrial machine that does not require computing capability; and
calculating whether a time required to complete the step is sufficient to perform the software update installation based on the installation time estimate.

13. The computing system of claim 8, further comprising identifying, by the processor, a location on an industrial floor to move the industrial machine to perform the software update installation.

14. The computing system of claim 8, further comprising engaging, by the processor, the industrial machine to complete a predefined task in advance of the planned time of the software update installation.

15. A computer program product for scheduling a software update installation on industrial machines in an Internet of Things (IOT) environment, the computer program product comprising a computer readable storage device, and program instructions stored on the computer readable storage device, to:
receive, by a processor, a plurality of log files and IoT data feeds related to a set of industrial machines;
calculate, by the processor, using the plurality of log files, an installation time estimate to perform the software installation;
analyze, by the processor, using the plurality of log files and IoT data feeds, a set of activities and an activity sequence related to a workflow execution using a machine learning technique to identify a planned time and sequence of a software update installation on an industrial machine among the set of industrial machines based on the installation time estimate, wherein the set of industrial machines are part of an integrated workflow system;
perform, by the processor, a digital twin simulation to identify a potential negative impact in the workflow execution based on a downtime of the industrial machine during the planned time of the software update installation; and
proactively reconfigure, by the processor, a resource allocation to minimize the potential negative impact.

16. The computer program product of claim 15, further comprising program instructions stored on the computer readable storage device to perform the software installation on the industrial machine based on the planned time and sequence.

17. The computer program product of claim 15, wherein the step to analyze the set of activities and the activity sequence related to a workflow execution includes identifying how the industrial machine collaborates with the remaining industrial machines in the set of industrial machines.

18. The computer program product of claim 15, wherein the step to analyze the set of activities and the activity sequence related to a workflow execution includes identifying which activities among the set of activities is performed in parallel and which activities among the set of activities are performed in sequence and an estimated time duration to perform each activity among the set of activities.

19. The computer program product of claim 15, wherein the step to analyze the set of activities and the activity sequence related to a workflow execution further comprises program instructions stored on the computer readable storage device to:
identify a step of an activity related to the industrial machine that does not require computing capability; and
calculate whether a time required to complete the step is sufficient to perform the software update installation based on the installation time estimate.

20. The computer program product of claim 15, wherein the step to analyze the set of activities and the activity sequence related to a workflow execution further comprises program instructions stored on the computer readable storage device to identify a location on an industrial floor to move the industrial machine to perform the software update installation.
